(19) United States
(12) Patent Application Publication
(10) Pub. No.: US 2005/0099028 A1
(43) Pub. Date: May 12, 2005

(54) Energy absorbing system

(76) Inventor: Simon Orton, Geebung QLD (AU)

Correspondence Address: RENNER, OTTO, BOISSELLE & SKLAR, LLP;Nineteenth Floor, 1621 Euclid Avenue, Cleveland, OH, 44115-2191, US

(21) Appl. No.: 10/927,543

(22) Filed: Aug. 26, 2004

(30) Foreign Application Priority Data
Aug. 27, 2003 (AU) 2003904612

(51) Int. Cl. B60R 19/34

(52) U.S. Cl. 293/133

(57) ABSTRACT

An energy absorbing system including a first connection portion for connection to a first structure, a second connection portion for connection to a second structure, an energy absorbing means including first and second spaced apart wall portions and a control means for controlling deformation of at least part of the energy absorbing means during energy absorption resulting from an impact on the first structure whereby one end portion of the energy absorbing means is adapted to deform before the other end portion.

The present invention relates primarily to vehicles and in a particular application relates to energy absorbing systems for vehicles.

According to one application the energy absorbing system of the invention may be incorporated in an assembly used to mount a protective bar such as a bull bar to the front of a vehicle.

### BACKGROUND OF THE INVENTION

Typically a bull bar is mounted to a vehicle using mounting brackets which at one end are connected to the chassis of the vehicle underneath the vehicle bumper bar and at the other end are connected to the bull bar.

The problem with existing mounting brackets is that they are not specifically adapted to do anything other than hold the bull bar in place. If the bull bar is hit by something the bull bar is supposed to absorb the majority of the impact and prevent or reduce transferal of any significant impact forces to the vehicle itself. If the vehicle is involved in an accident in which significant impact forces are experienced by the bull bar then the majority of the impact forces will ultimately be transferred to the vehicle. In such a situation the vehicle itself must be designed to absorb forces associated with the impact and to protect the occupants of the vehicle. Most modern vehicles therefore have air bags to protect the occupants.

Thus it is more common that bull bars are used as a buffer for minor impact. However, because of the design of most modern vehicles it is desirable that a bull bar be mounted in a manner which does not seriously affect the normal functioning of air bags or energy absorbing design of the vehicle.

### SUMMARY OF THE INVENTION

The present invention is aimed at providing an energy absorbing system which may assist with mounting protective bars such as bull bars to a vehicle in a manner which is able to assist the energy absorbing characteristics of the vehicle to which the bull bar is attached. The energy absorbing system may also be applicable to other situations where mechanical devices are required to absorb impact forces.

According to the present invention there is provided an energy absorbing system comprising a first connection portion for connection to a first structure, a second connection portion for connection to a second structure, an energy absorbing means including first and second spaced apart wall portions and a control means for controlling deformation of at least part of the energy absorbing means during energy absorption resulting from an impact on the first structure whereby one end portion of the energy absorbing means is adapted to deform before the other end portion.

It is preferred that the first structure includes a protective bar and the second structure includes a chassis of a vehicle.

It is preferred that the first connection portion is configured for connection to the first structure through a first mounting means.

Preferably the second connection portion is configured for connection to the second structure through a second mounting means.

The energy absorbing means may comprise a hollow section at least in part formed by the first and second wall portions.

It is preferred that the hollow section has upper and lower end portions.

The one end portion may correspond with the upper end portion.

The hollow section preferably comprises a plurality of wall portions including the first and second wall portions.

The first wall portion may include a front wall portion and a rear wall portion.

The second wall portion may include a front wall portion and a rear wall portion.

Preferably the first and second wall portions are connected at front and rear ends.

Preferably the front wall portions are connected at the front ends and the rear wall portions are connected at the rear ends.

The front wall portions preferably diverge from the front ends.

The rear wall portions preferably diverge from the rear ends.

It is preferred that the rear end of the front portion and the front end of the rear portion of the first portion are connected.

Preferably the rear end of the front portion and the front end of the rear portion of the first portion are integrally formed together.

It is preferred that the front and rear portions are separated by a bend.

Preferably the front and rear portions extend outwardly towards each other.

The hollow section may have a quadrilateral cross-section.

According to another embodiment the hollow section has either one of the following cross-sections:
diamond shaped, trapezoidal, triangular, elliptical, circular, other geometrical shape, an irregular shape with a space separating the first and second walls.

According to another embodiment the energy absorbing means includes additional wall portions.

The first connection portion may have a rear end connected directly or indirectly with the energy absorbing means.

The rear end of the first connection portion may connect with the first and second wall portions.

It is preferred that the first connection portion has its rear end connected to the front wall portions of the first and second wall portions.

According to another embodiment the first connection portion has a rear end connected to the junction of front wall portions.

It is preferred that the first connection portion extends axially.

It is preferred that the system extends generally in an axial direction.

The energy absorbing means may be aligned axially with the first connection portion to absorb energy from an impact transferred to the connection portion.

It is preferred that the first connection portion extends co-linear with front and rear corners of the energy absorbing means hollow section.

The front wall portions preferably diverge from the first connection portion at approximately 45°.

The front and rear wall portions preferably diverge at approximately 45°.

The second connection portion may have a front end connected to the rear end of the energy absorbing means.

The front end of the second connection portion may be connected to the first and second walls.

It is preferred that the front end of the second connection portion is connected to the rear ends of the rear wall portions.

Preferably the front end of the second connection portion is connected to the junction of the rear wall portions.

The second connection portion preferably extends axially.

The second connection portion may extend co-linear with the front and rear corners of the hollow section.

The first connection portion may be substantially planar.

The second connection portion may be substantially planar.

It is preferred that the first and second connection portions are substantially co-planar.

The hollow section may have upper and lower ends.

The upper and lower ends may be adjacent upper and lower ends of the first and second connection portions.

The upper end of the hollow section may be substantially co-planar with the upper end of the first and/or second connection portion.

The first and second connection portions may respectively include additional connection portions.

The upper ends of the first and second wall portions may be substantially flush with the upper ends of the first and/or second connection portion.

Preferably upper ends of the wall portion of one of the first or second wall portions is substantially parallel with rear wall portions of the other of the first or second wall portions.

The hollow section may include wall portions which are curved, flat, irregular or include additional features.

It is preferred that the lower end of the hollow section slopes downwardly from the front end to the rear end.

The energy absorbing means may be adapted to crumple, deform, buckle first at one of the upper or lower ends.

The control means may include a strengthening means for strengthening one of the upper/lower ends.

The control means may include weakening means for weakening one of the upper or lower ends.

It is preferred that the strengthening means includes a strengthening assembly.

The strengthening means may include a plurality of strengthening portions.

The strengthening means may include a strap.

The strengthening means may include at least one member for bridging the first and second connection portions.

It is preferred that the strengthening means includes at least one member connected between the first and second connection portions.

It is preferred that the members are connected at upper ends of the first and second connection portions.

According to one embodiment the strengthening means comprises a device for reducing deformability of the upper end of the energy absorbing means/hollow member.

The strengthening means may comprise a member located inside the hollow section.

Preferably the strengthening means comprises a device connected to the upper end of the hollow section/first and second wall portions.

The strengthening means may comprise a device for at least partially closing the upper end of the hollow section.

Preferably the device for reducing deformability includes at least one member.

The strengthening means may comprise a first generally planar member.

Preferably the first generally planar member is connected between the first and second connection portions.

It is preferred that the strengthening means includes a second member connected to an upper end of the first connection portion.

The second member is preferably generally planar.

The second member is preferably connected to the top edge of the first connection portion.

It is preferred that the second member is connected across the top edge of first connection portion.

Preferably the second member is connected symmetrically across the top edge of the first connection portion.

The first and second connection portions are preferably planar.

The strengthening means may include a third member which may be generally planar and which is connected to the upper end of the second connection portion.

It is preferred that the third member is connected to the top edge of the second connection portion.

The third member may be connected across the top edge of the second connection portion.

The third connection portion may be connected symmetrically across the top edge of the second connection portion.

It is preferred that a rear end of the third member is connected to a rear end of the second connection portion.

According to one embodiment the first member has a buckled portion or fold.

It is preferred that the first member is bent approximately at its mid section.

Preferably the first member has an apex at its buckled portion which is above the hollow section.

Preferably the apex is located approximately above the mid point of the hollow section.

Preferably the first member interconnects the second and third members.

The strengthening means may include an insert located in an upper end of the hollow section.

It is preferred that the hollow section and strengthening means form a T-shaped configuration.

The strengthening means is preferably adapted to resist a predetermined impact force applied to the front end of the first connection portion.

It is preferred that the strengthening means is adapted to resist a predetermined impact force applied at an angle upwardly with respect to the axial direction of the system.

Preferably the strengthening means is adapted to oppose a rotational force applied to the hollow section.

According to one embodiment the strengthening means is adapted to resist a predetermined impact force before absorbing impact energy.

Preferably the strengthening means is adapted to resist a predetermined impact force applied to the first connection portion before deformation of the energy absorbing means.

It is preferred that the upper end of the hollow section is configured to resist a first predetermined impact force applied axially before deforming/absorbing energy.

It is preferred that the lower end of the hollow section is configured to resist a second predetermined impact force applied axially before deforming/absorbing energy.

Preferably the first predetermined impact force is greater than the second predetermined impact force.

The weakening means may comprise one or more weaknesses provided in the lower end of the first and/or second wall portions.

The weakening means may include perforations in one or more walls.

The weakening means may include openings in one or more walls.

Preferably the weakening means includes a sloping lower edge of lower end wall portions of the hollow section.

Weakening means may include a device for assisting deformation of the lower end of the hollow section before the upper end thereof.

It is preferred that the weakening means includes a slope from the front to the rear end of the first and second wall portions.

Preferably the weakening means includes a length difference between the front ends compared to the rear ends of the first and second wall portions.

The slope from the front lower end to the rear lower end may be greater than 45° with respect to vertical.

The slope of the front lower edge wall portion may be less than the slope of the rear lower edge wall portion.

It is preferred that the vertical length of the front wall portion(s) is less than the vertical length of the rear wall portion(s).

Preferably the vertical length of the front wall portions approaches two thirds of the length of the rear wall portion length.

The first connection portion preferably has substantially parallel upper and lower edges.

The second connection portion preferably has upper and lower edges which slightly converge from the rear end of the rear wall portions.

It is preferred that the front of the front wall portions has a greater vertical length than the end of the end wall portions.

The first and second connection portions may be angled with respect to each other.

It is preferred that the first connection portion, second connection portion and energy absorbing means are adapted to be inclined upwardly from the second supporting structure, e.g. chassis of a vehicle.

The combined first and second connection portions and energy absorbing means are preferably oriented at 45° or less with respect to the horizontal.

It is preferred that the first structure is adapted to be connected to the first connection portion substantially vertically.

It is preferred that the first structure is connected to the first connection portion square on to the front of the first connection portion.

It is preferred that the first structure is aligned in parallel vertically with the front of a vehicle of the second structure.

It is preferred that the connection portion includes a coupling portion for coupling a protective bar to the first coupling portion.

It is preferred that the first and second walls include a plurality of deformations.

It is preferred that the hollow section includes a plurality of vertical deformations.

The strengthening means may include a plurality of deformable members.

Preferably the hollow section is adapted to be oriented at approximately 45° angle with respect to the vertical.

Preferably the energy absorbing system includes an assembly including the first connection, the second connection portion, the energy absorbing means and the control means.

It is preferred that the energy absorbing system is in the form of a mounting means for interconnecting a protective bar and a chassis of a vehicle.

According to one embodiment the system is adapted to transmit a predetermined impact force to the chassis of a vehicle whereby a triggering means is able to trigger an air bag safety system of the vehicle.

According to another aspect of the present invention there is provided an assembly incorporating first and second energy absorbing systems spaced apart and axially aligned in parallel.

According to another embodiment the energy absorbing system includes a mounting system for mounting a protective bar to a chassis of the vehicle including a plurality of energy absorbing systems.

It should be understood that for convenience terms such as a front, rear, upper and lower have been used to provide a frame of reference for describing various optional features of the invention in a typical application where an assembly is used for mounting a bull bar to a vehicle. However, the energy absorbing system may be considered in different orientations including an orientation in which front becomes rear and upper becomes lower.

It should also be understood that where terms are referred to in the singular they also include more than one unless preceded by the word “only”.

### BRIEF DESCRIPTION OF THE DRAWINGS

Preferred embodiments of the present invention will now be described by way of example only with reference to the accompanying drawings in which:

FIG. 1 shows a right side angled view of an energy absorbing assembly in accordance with a preferred embodiment of the present invention;

FIG. 2 shows an angled view of the left hand side of the assembly shown in FIG. 1;

FIG. 3 shows an angled view of the left hand side of the assembly viewed from above;

FIG. 4 shows a front angled view of a mounting assembly including the assembly of the preferred embodiment of the present invention; and

FIG. 5 shows a rear angled view of a mounting assembly for a protective bar according to a preferred embodiment of the present invention.

### DETAILED DESCRIPTION

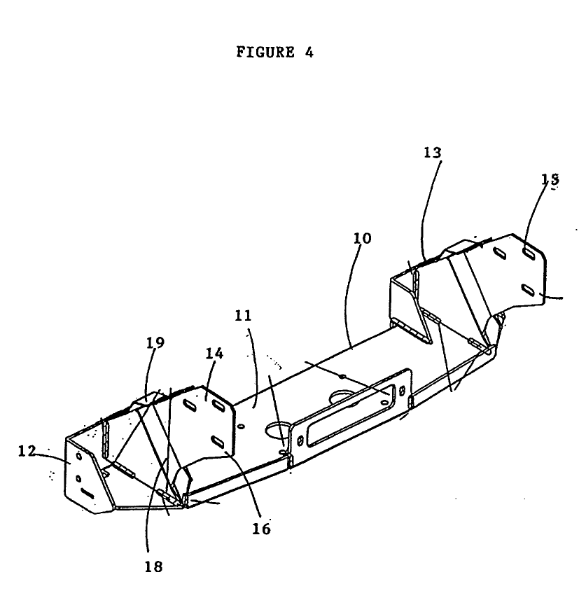

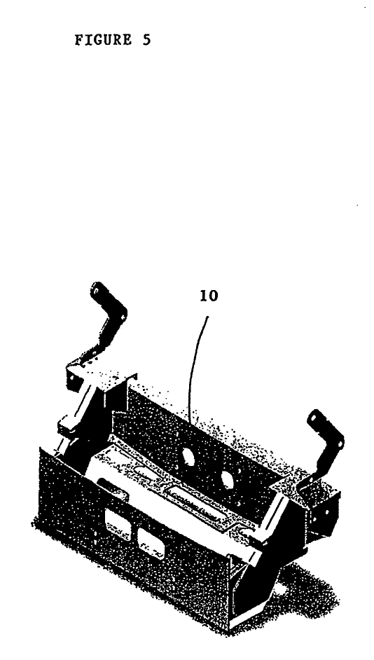

According to the preferred embodiment of the invention a mounting assembly for a protective bar incorporates a mounting frame structure 10 shown most clearly in FIGS. 4 and 5. In the example shown this structure 10 has a horizontal base surface 11 with mounting holes to allow a winch to be attached thereto. On left and right hand sides of this structure, upright mounting brackets 12 and 13 are provided extending around the left and right side rear corners of the structure 10. The brackets 12 and 13 are provided with appropriately located holes to allow the structure 10 to be bolted to the front chassis of a vehicle.

Support arms 14 and 15 are provided at the right and left hand ends of the structure 10 and extend from the back of the structure 10 to the front of the structure 10 at an angle which may be 45° approximately with respect to the horizontal base surface 11.

The front end of the support arms 14, 15 is provided with mounting holes to allow a mounting bracket to attach left and right sides of a protective bar thereto.

The front parts 16, 17 as shown in FIG. 4 have an upper horizontal edge and front vertical edge and mounting holes which make it easy to orient the protective bar in a vertical orientation with respect to the vehicle and the base horizontal surface 11 of the mounting structure 10.

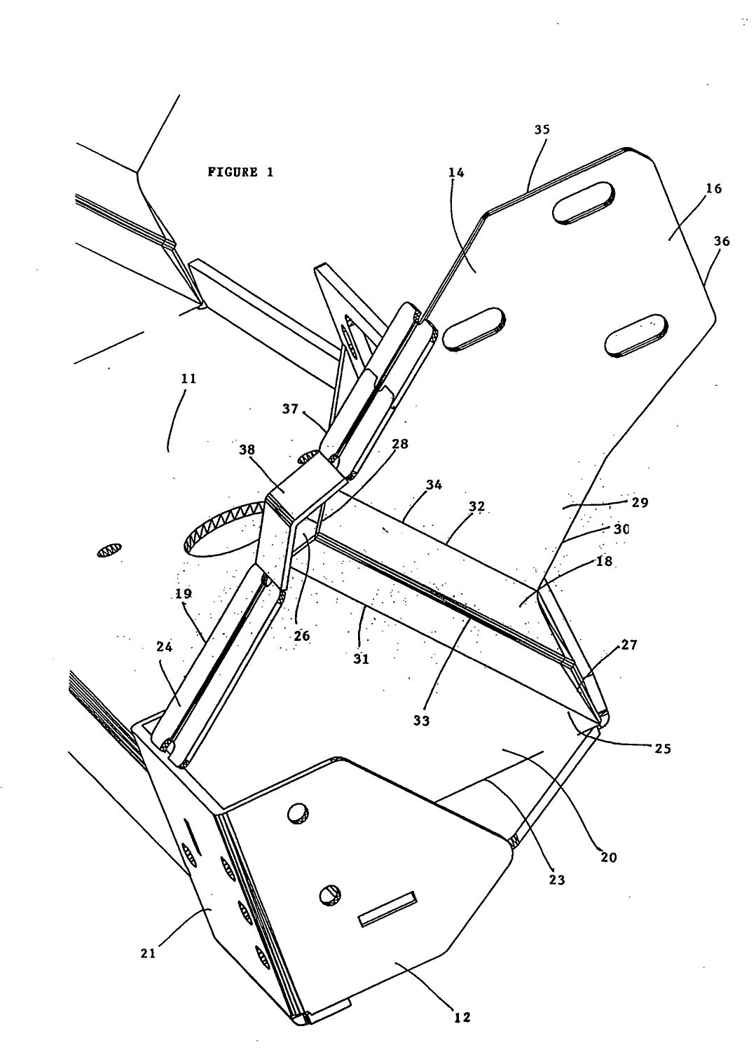

Each of the support arms 14, 15 incorporate a primary energy absorbing section 18 and a secondary energy absorbing section 19 shown in greater detail in FIGS. 1 to 3.

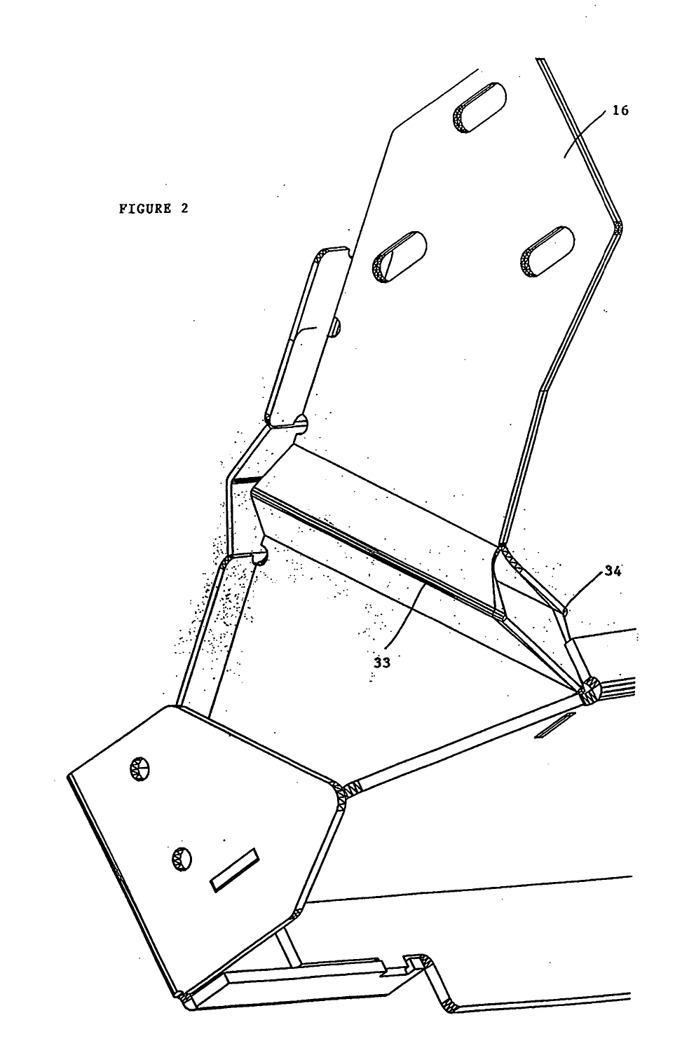

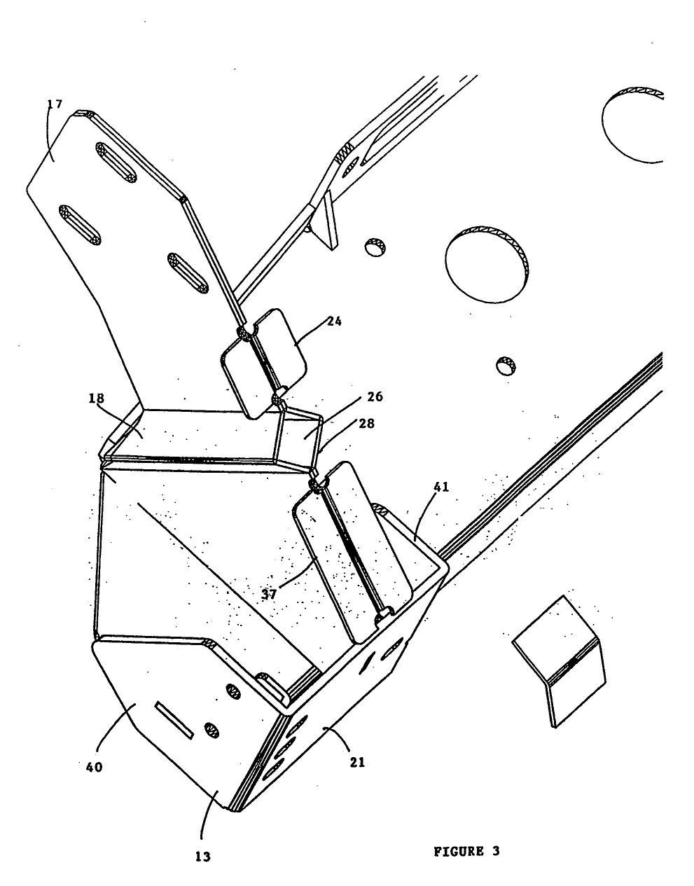

As the left and right side support arms are substantially identical features described in relation to the left hand side of the mounting structure shown in FIGS. 1 and 2 are the same as those for the right hand side of the structure shown in FIG. 3.

As shown in FIG. 1 the support arm 14 is generally planar with a rear plate section 20 oriented perpendicular to the horizontal base 11 and extending forward from the rear wall 21 of left side bracket 12.

The lower edge 23 of rear section 20 extends to the front edge of base surface 11 and is spaced inwardly and in parallel with the outer side wall of bracket 12.

The top edge of rear section 20 slopes upwardly at approximately 45° and has a rearward section 24 of the secondary energy absorbing section 19 welded perpendicular thereto.

A front section 25 of rearward section 20 extends from the front lower edge to the top edge and is oriented at substantially 90° to the top edge.

This section extends into the primary energy absorbing section 18.

The primary energy absorbing section 18 is integrally formed or connected to the front section 21 and is thus oriented at around 45° in a rearward direction from the front edge of the horizontal base surface 11.

The primary energy absorbing section 18, 19 consists of a trapezoidal tubular structure with a trapezoidal passage extending from the lower end 27 to the upper end 28. The edges 29 of the top end 28 are generally flush with the top edge of the rear section 20 and front section 29. The lower edges 27 however incline steeply upwardly from the front of the horizontal base surface 11 to the lower edge 30 of front section 29.

The primary energy absorbing section 18, 19 is configured to have front and rear edges 31, 32 aligned with the front edge 25 and rearward edge 33 of the rear and front sections 20 and 29 respectively. It follows that the other two edges of the section 18,19, 33, 34 are symmetrically arranged on either side of the general plane in which the arms 14 and 15 extend.

The front section 29 extends in the same general direction at approximately 45° from the horizontal base surface from the front edge 32 of section 18, 19. As previously described at its outer end the front section 29 is configured to have a head or nose section incorporating a horizontal top surface 35 and vertical front surface 36.

Three mounting slots 37 are provided to allow a bull bar to be connected thereto through a mounting plate.

The secondary energy absorbing section 19 consists of rear plate section 24, front section 37 and mid section 38.

The rear section 24 extends from the top edge of rear wall 21 of bracket 12 to a region close to but before the front edge of the primary energy absorbing section 31.

The middle section 38 extends upwardly at an angle from the front edge of rear section 24 to an apex 39 extending laterally across the passage 26 approximately above edges 33 and 34 and slopes downwardly again at approximately the same angle to the rearward edge of front section 37. Front section 27 then extends forward approximately halfway along the top edge before the horizontal edge 35 of front section 29.

The function of the primary and secondary energy absorbing sections will now be described as follows.

When the mounting structure is in use it is attached to the chassis of a vehicle through mounting brackets 12 and 13. A protective bar such as a bull bar is connected to the mounting arms 14,15 so that the protective bar is generally oriented vertically so as to encounter any impact forces before the vehicle chassis.

If a vehicle with the assembly described above mounted to it hits a structure while travelling at speed, for a front on collision, impact forces are initially experienced by the protective bar. These forces pass through the bar to the mounting arms 14, 15 and are ultimately transmitted through to the chassis of the vehicle. However impact forces experienced by the mounting arms 14, 15 tend to force each front section rearwardly. These forces are then transmitted to the primary energy absorbing section 18 which is designed to deform or crumple, absorbing energy associated with the impact forces in the process. The primary energy absorbing section works more efficiently if impact forces are directed axially so as to strike the front edge 34. In reality this would be unlikely to occur as impact forces are more likely to have at least some component which is not aligned with the axis of each arm. This would result in the primary energy absorbing section not necessarily absorbing energy in the most efficient manner. Ultimately this could result in ineffective operation of the primary energy absorbing section 18, 19.

In some embodiments it may be preferable that the mounting arms are oriented so that the primary energy absorbing section is oriented vertically.

To provide some control over the operation of the primary energy absorbing section, the secondary energy absorbing section provides a predetermined amount of strengthening to the upper end of the primary energy absorbing section 18, 19. In addition the lower end of the primary energy absorbing section is weakened by having a lower sloping edge from the rear edge 31 to the front edge 34. Thus as a significant amount of the front walls and to a lesser extent the rear walls have been eliminated or cut away, there is less strength to resist any impact forces at the lower end of the primary energy absorbing section 18, 19. The combined effect of both of these strengthening and weakening features results in a tendency of any impact forces received by the primary energy absorbing section to deform the lower end of this section before the upper end. Therefore initially impact forces are able to pass more easily to the chassis of the vehicle through the lower regions of each mounting arm. This can enable enough forces to be transmitted initially during a collision for any anti-collision systems of the vehicle to operate. For example an airbag may be able to operate from the initially transmitted forces.

Another benefit with the above configuration may be a slight reorientation of the primary energy absorbing section so that it is slightly more upright and facing impact forces head on.

Once a predetermined amount of impact force has been transmitted the primary and secondary energy absorbing sections are able to absorb much more of the impact forces. This is achieved by crumpling of the primary energy absorbing section so that the front and rear edges move closer together and the lateral edges 33, 34 move further apart. In addition the secondary energy absorbing section absorbs energy through the mid section 38 which is able to bend further as the front section 37 is pushed towards the rear section 24. It is preferred that each of the front, middle and rear sections are metal plates which are welded together and welded to the top edges of the rear and front sections 20, 29.

By having the mid section 38 not connected to the upper edges 28 of the primary energy absorbing section this allows both sections to operate independently.

It is noted however that other options may be used to strengthen the upper end of the primary energy absorbing section such as having a strengthening plate, tube, or other structure located inside the top end of the passage 26. Alternatively gussets or strengthening members may be added to the outer walls at the upper end of the primary energy absorbing section to provide a predetermined amount of resistance to deformation but to ultimately allow energy absorption.

Weakening of the lower end of the primary energy absorbing section may also be provided by providing holes, openings or perforations in the lower end of the primary energy absorbing section.

The trapezoidal shape of the tubular section may also be changed to a different geometrical shape whereby walls of the primary energy absorbing section are able to deform to absorb energy.

It is preferred that the lower end of the tubular structure is inclined at an acute angle wherein at least one quarter of the front walls are at least partially removed.

It is noted that a greater amount of the front walls of the tubular section is removed at the lower ends compared to the rear two walls. As shown in FIG. 3 the right hand side of the mounting structure is provided with a similar mounting arm 17. For convenience the mid section of the secondary energy absorbing section has been removed to show the trapezoidal cross-section of the primary energy absorbing section.

It is also easier to see the mounting bracket 13 which has a U-shaped configuration with the rear vertical wall 21 and spaced apart side walls 40, 41 extending at right angles forwardly with the mounting arm rear section located closer to the inner side wall 41.

It is preferred that the energy absorbing system allows the ability to tune the design of the vehicle air bag trigger system associated with the vehicle to which the energy absorbing system is mounted.

According to another embodiment it may be desirable to have the primary energy absorbing section oriented more to the vertical.

It is to be understood that, if any prior art publication is referred to herein, such reference does not constitute an admission that the publication forms a part of the common general knowledge in the art, in Australia or in any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. An energy absorbing system comprising a first connection portion for connection to a first structure, a second connection portion for connection to a second structure, an energy absorbing means including first and second spaced apart wall portions and a control means for controlling deformation of at least part of the energy absorbing means during energy absorption resulting from an impact on the first structure whereby one end portion of the energy absorbing means is adapted to deform before the other end portion.

2. The energy absorbing system as claimed in claim 1 wherein the first connection portion is configured for connection to the first structure through a first mounting means.

3. The energy absorbing system as claimed in claim 1 wherein the second connection portion is configured for connection to the second structure through a second mounting means.

4. The energy absorbing system as claimed in claim 1 wherein the energy absorbing means comprises a hollow section at least in part formed by the first and second wall portions.

5. The energy absorbing system as claimed in claim 4 wherein the hollow section has upper and lower end portions.

6. The energy absorbing system as claimed in claim 5 wherein the one end portion incorporates the upper end portion.

7. The energy absorbing system as claimed in claim 5 wherein the hollow section comprises a plurality of wall portions including the first and second wall portions.

8. The energy absorbing system as claimed in claim 7 wherein the first wall portion includes a front wall portion and a rear wall portion.

9. The energy absorbing system as claimed in claim 8 wherein the second wall portion includes a front wall portion and a rear wall portion.

10. The energy absorbing system as claimed in claim 9 wherein the first and second wall portions are connected at front and rear ends.

11. The energy absorbing system as claimed in claim 10 wherein the front wall portions are connected at the front ends and the rear wall portions are connected at the rear ends.

12. The energy absorbing system as claimed in claim 11 wherein the front wall portions diverge from the front ends.

13. The energy absorbing system as claimed in claim 12 wherein the rear wall portions diverge from the rear ends.

14. The energy absorbing system as claimed in claim 13 wherein the rear end of the front portion and the front end of the rear portion of the first portion are connected.

15. The energy absorbing system as claimed in claim 14 wherein the front and rear portions are separated by a bend.

16. The energy absorbing system as claimed in claim 15 wherein the front and rear portions extend outwardly towards each other.

17. The energy absorbing system as claimed in claim 6 wherein the hollow section has either one of the following cross-sections:
diamond shaped, trapezoidal, triangular, elliptical, circular, quadrilateral.

18. The energy absorbing system as claimed in claim 11 wherein the rear end of the first connection portion connects with the first and second wall portions.

19. The energy absorbing system as claimed in claim 18 wherein the first connection portion has its rear end connected to the front wall portions of the first and second wall portions.

20. The energy absorbing system as claimed in claim 18 wherein the first connection portion has a rear end connected to the junction of the front wall portions.

21. The energy absorbing system as claimed in claim 1 wherein the energy absorbing means is aligned axially with the first connection portion to absorb energy from an impact transferred to the connection portion.

22. The energy absorbing system as claimed in claim 6 wherein the first connection portion is co-linear with front and rear corners of the energy absorbing means hollow section.

23. The energy absorbing system as claimed in claim 18 wherein the front wall portions diverge from the first connection portion at approximately 45°.

24. The energy absorbing system as claimed in claim 18 wherein the front and rear wall portions diverge at approximately 45°.

25. The energy absorbing system as claimed in claim 10 wherein the second connection portion has a front end connected to the rear end of the energy absorbing means.

26. The energy absorbing system as claimed in claim 25 wherein the front end of the second connection portion is connected to the first and second walls.

27. An energy absorbing system comprising a first connection portion for connection to a first structure, a second connection portion for connection to a second structure, an energy absorbing means including first and second spaced apart wall portions and a control means for controlling deformation of at least part of the energy absorbing means during energy absorption resulting from an impact on the first structure wherein one end portion of the energy absorbing means is adapted to deform before the other end portion and wherein the energy absorbing means comprises a hollow section with upper and lower ends.

28. The energy absorbing system as claimed in claim 27 wherein the control means includes a strengthening means for strengthening one of the upper or lower ends.

29. The energy absorbing system as claimed in claim 27 wherein the control means includes a weakening means for weakening one of the upper or lower ends.

30. The energy absorbing system as claimed in claim 28 wherein the strengthening means includes at least one member connected between the first and second connection portions.

31. The energy absorbing system as claimed in claim 30 wherein the or each member connected between the first and second connection portions are connected at upper ends of the first and second connection portions.

32. The energy absorbing system as claimed in claim 27 wherein the strengthening means comprises a device for reducing deformability of the upper end of the energy absorbing means.

33. The energy absorbing system as claimed in claim 27 wherein the strengthening means comprises a member located inside the hollow section.

34. The energy absorbing system as claimed in claim 27 wherein the strengthening means comprises a device connected to the upper end of the hollow section which at least partially closes the upper end of the hollow section.

35. The energy absorbing system as claimed in claim 29 wherein the strengthening means comprises a first generally planar member connected between the first and second connection portions.

36. The energy absorbing system as claimed in claim 35 wherein the strengthening means includes a second member connected to an upper end of the first connection portion.

37. The energy absorbing system as claimed in claim 36 wherein the second member is generally planar and is connected to the top edge of the first connection portion.

38. The energy absorbing system as claimed in claim 37 wherein the second member is connected symmetrically across the top edge of the first connection portion.

39. The energy absorbing system as claimed in claim 28 wherein the strengthening means includes a plurality of members which are generally planar and connected to the upper end of the second connection portion.

40. The energy absorbing system as claimed in claim 36 wherein the strengthening means includes a third member which is connected to the upper end of the second connection portion.

41. The energy absorbing system as claimed in claim 40 wherein the third connection portion is connected symmetrically across the top edge of the second connection portion.

42. The energy absorbing system as claimed in claim 40 wherein a rear end of the third member is connected to a rear end of the second connection portion.

43. The energy absorbing system as claimed in claim 38 wherein the first member is bent approximately at its mid-section.

44. The energy absorbing system as claimed in claim 43 wherein the first member has an apex at its buckle portion which is substantially above the hollow section.

45. The energy absorbing system as claimed in claim 44 wherein the apex is located approximately above the midpoint of the hollow section.

46. The energy absorbing system as claimed in claim 43 wherein the first member interconnects the second and third members.

47. The energy absorbing system as claimed in claim 28 wherein the strengthening means is adapted to resist a predetermined impact force applied to the front end of the first connection portion.

48. The energy absorbing system as claimed in claim 28 wherein the strengthening means is adapted to resist a predetermined impact force applied at an angle upwardly with respect to the axial direction of the system.

49. The energy absorbing system as claimed in claim 29 wherein the weakening means comprises at least one weakness provided in the lower end of the first and/or second wall portions.

50. The energy absorbing system as claimed in claim 49 wherein the weakening means includes a plurality of openings in one or more walls.

51. The energy absorbing system as claimed in claim 49 wherein the weakening means includes a sloping lower edge of lower end wall portions of the hollow section.

52. The energy absorbing system as claimed in claim 29 wherein the weakening means includes a device for assisting deformation of the lower end of the hollow section before the upper end thereof.

53. The energy absorbing system as claimed in claim 27 wherein the hollow section is adapted to be oriented at approximately a 45° angle with respect to the vertical.

54. An energy absorbing system comprising a first connection portion for connection to a protective bar, a second connection portion for connection to a chassis of a vehicle, an energy absorbing means including first and second spaced-apart wall portions and a control means for controlling deformation of at least part of the energy absorbing means during energy absorption resulting from an impact on the first structure, whereby one end portion of the energy absorbing means is adapted to deform before the other end portion and wherein the system is adapted to transmit a predetermined impact force to the chassis of a vehicle whereby a triggering means is able to trigger an airbag safety system of the vehicle.
